(19) United States
(12) Patent Application Publication
(10) Pub. No.: US 2015/0022646 A1
(43) Pub. Date: Jan. 22, 2015

(54) System and Method for Display of Image Streams

(71) Applicant: Ryan Douglas Brooks, Kitchener (CA)

(72) Inventor: Ryan Douglas Brooks, Kitchener (CA)

(21) Appl. No.: 14/269,442

(22) Filed: May 5, 2014

Related U.S. Application Data
(60) Provisional application No. 61/980,437, filed on Apr. 16, 2014.
(60) Provisional application No. 61/878,920, filed on Sep. 17, 2013.
(60) Provisional application No. 61/847,157, filed on Jul. 17, 2013.

(51) Int. Cl. H04N 13/04; G02B 27/26; G02B 27/22

(52) U.S. Cl. CPC H04N 13/0438; G02B 27/2228; G02B 27/26
USPC 348/52

(57) ABSTRACT

A system for projecting a first image stream containing a first set of frames for displaying primary content and a second image stream containing a second set of frames that contain alternate content and for allowing a user to configure passive filters to alternate between viewing the first image stream and the second image stream.

### CROSS-REFERENCE TO RELATED APPLICATION

The present application claims priority benefit of U.S. Provisional Patent Application No. 61/980,437 filed Apr. 16, 2014; U.S. Provisional Patent Application No. 61/878,920 filed Sep. 17, 2013; and, U.S. Provisional Patent Application No. 61/847,157 filed Jul. 17, 2013; all of which are incorporated herein by reference.

### TECHNICAL FIELD

The present invention relates generally to the field of entertainment systems, and more particularly to a system including interactive revealing eyewear and methods of using the system for viewing visual entertainment.

### BACKGROUND ART

The basic principles of stereoscopic imaging are well known. Human vision is stereoscopic because each eye views the same scene from a different angle. The two separate images are combined by the brain to create a stereoscopic effect. In order to recreate the stereoscopic appearance of a scene on a flat screen, the scene must be captured by two cameras, one representing what a left eye would normally see, and one representing what a right eye would normally see. The left and right images are then interlaced so as to originate from the same location. A stereoscopic or three-dimensional image is obtained when each eye sees only the corresponding left and right eye portions of the interlaced image. There are different ways to optically modify the left and right eye portions of spatially interlaced images so that the left eye sees only the left eye portion of the interlaced image and the right eye sees only the right eye portion of the interlaced image. One way is to color the left and right eye portions of the interlaced image and to use color filters to ensure that the left and right eyes see only the correspondingly colored portions of the interlaced image. Another way to modify the left and the right eye images so that each eye will only see appropriate portions of the interlaced image is to polarize the left and right eye images in opposite directions, and to use oppositely polarized lenses to view the oppositely polarized portions of the interlaced image.

Polarization has significant advantages over color filtering in that it permits the stereoscopic image to be viewed in natural color with reduced light loss compared to color filtering.

In addition, polarization has the advantage that a person wearing polarized lenses can turn away from the interlaced image and view other objects or persons without having to take off the lenses. Since the polarizers and polarizing lenses have a substantially colorless appearance, the stereoscopic effect can be created with what appears to the viewer to be ordinary clear lenses, as opposed to color lenses used in conventional non-polarizing stereoscopic systems.

Another way to accomplish stereoscopic viewing is an active shutter system which allows the left and right eyes of the viewer to independently receive the L and R images by opening and closing liquid crystal shutters of left and right glasses in synchronization with alternate displays of the left and right images.

FIG. 1 illustrates the principle of stereoscopic viewing. The 3D glasses 10 are used to allow the left and right eyes of the viewer to independently receive images (L and R images 13, 16) that create parallax between the eyes. Since a human being perceives a stereoscopic image of an object due to a difference between the images incident to the left and right eyes, the viewer perceives the depth in the displayed image 19.

As shown in FIG. 2, in one type of stereoscopic system, the left and right eye portions of the interlaced image 20 are colored. Color filters 23 and 26 are used to ensure that the left and right eyes see only the correspondingly colored portions of the interlaced image 20.

In contrast, the polarization system uses glasses that are provided with polarized filters and project L and R images that have been polarized and overlaid so that the left and right eyes of the viewer independently receive the L and R images.

In connection with stereoscopic systems, projection technology such as digital micro-mirror projectors (i.e., “digital light processing”) which are available under the DLP brand from Texas instruments, film patterned retarder (FPR) systems, or the like have been developed for projecting multiple image streams to a viewable screen.

### BRIEF SUMMARY OF THE INVENTION

With parenthetical reference to the corresponding parts, portions or surfaces of the disclosed embodiment, merely for the purposes of illustration and not by way of limitation, the present invention provides.

The present invention combines the multiple image projection technology of stereoscopic systems with polarization technology to provide a system for projecting a first image stream containing a first set of frames for displaying primary image content and a second image stream containing a second set of frames that contain alternate content and for allowing a user to configure a passive filter to alternate between viewing the first image stream and the second image stream. The alternate content may comprise the entirety of the primary image content plus additional content, or the primary image content may contain all of the alternate content plus additional content. It is also possible that the primary and alternate content are completely different.

The system may comprise a filter, for filtering frames from a first image stream, comprising circularly polarizing elements for polarizing the frames in a left-hand orientation, and a filter for filtering frames for the second image stream comprising circularly polarizing elements for polarizing the frames in a right-hand orientation, and further in respect of any subsequent image stream, filter elements for linearly polarizing the stream at varying angles equivalent to the filtering on the projected image stream. When for example the image streams are linearly polarized, a different assortment of filters is provided to accomplish the filtering of the projected images. Therefore the viewer can change the combination and superposition of filters to restrict or allow which of the image stream is permitted through the eyewear. The two or more filters allow different forms of light to pass. The filters include, but are not limited to, linear polarization, circular polarization, color exclusion/separation dichroic filters and other ways of isolating light.

In another aspect a method of viewing and filtering a plurality of image streams may include receiving image data comprising a plurality of image streams, each image stream comprising a plurality of frames; projecting the image data onto a viewable screen, wherein the projecting step comprises alternating between the various image streams; and filtering frames projected from each image stream through an alternate type of filter. The method may also include filtering for both eyes of a viewer the frames from the first image stream through an equivalent type of filter through which the first image stream is projected and for each additional image stream, the addition or subtraction of an additional type of filter which is equivalent to the type of filter through which the projected image stream is filtered.

### BRIEF DESCRIPTION OF THE DRAWINGS

FIG. 1 illustrates the principle of stereoscopic viewing;

FIG. 2 is a schematic diagram of a stereoscopic projection system;

FIG. 3 is a schematic diagram of a stereoscopic imaging arrangement;

FIG. 4 is a schematic diagram of a first embodiment of the present invention with eyewear disposed in a first configuration for viewing a primary image;

FIG. 5 is a schematic diagram showing the eyewear of FIG. 4 in a second configuration for viewing a combined image containing the primary image plus a “hidden” image that is revealed when the eyewear is worn in the second configuration;

FIG. 6A is a perspective view of a first embodiment of the eyewear of the present invention;

FIG. 6B is a detailed perspective view of one embodiment of a mounting system for the second frame;

FIG. 7 is an exploded view of the eyewear shown in FIG. 6A;

FIG. 8 is a perspective view of the eyewear shown in FIG. 6A;

FIG. 9 is another perspective view of the eyewear shown in FIG. 6A;

FIG. 10 is a perspective view of an alternate embodiment of the eyewear of the present invention;

FIG. 11 is a perspective view of an alternate embodiment of the eyewear of the present invention;

FIG. 12 is a perspective view of the eyewear of FIG. 11 in a first configuration; and,

FIG. 13 is a perspective view of the eyewear of FIG. 11 in a second configuration.

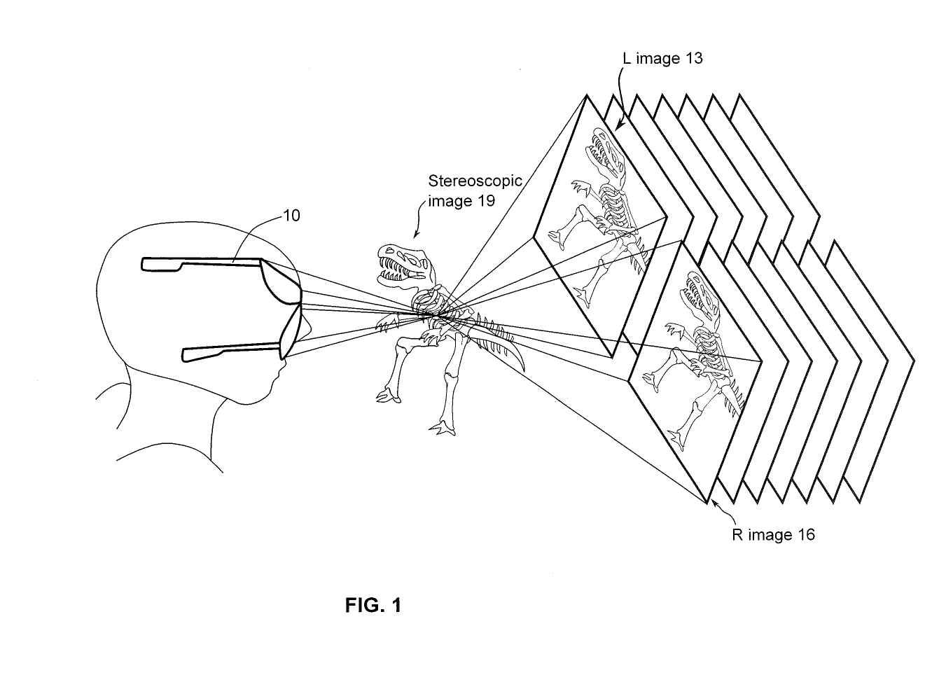

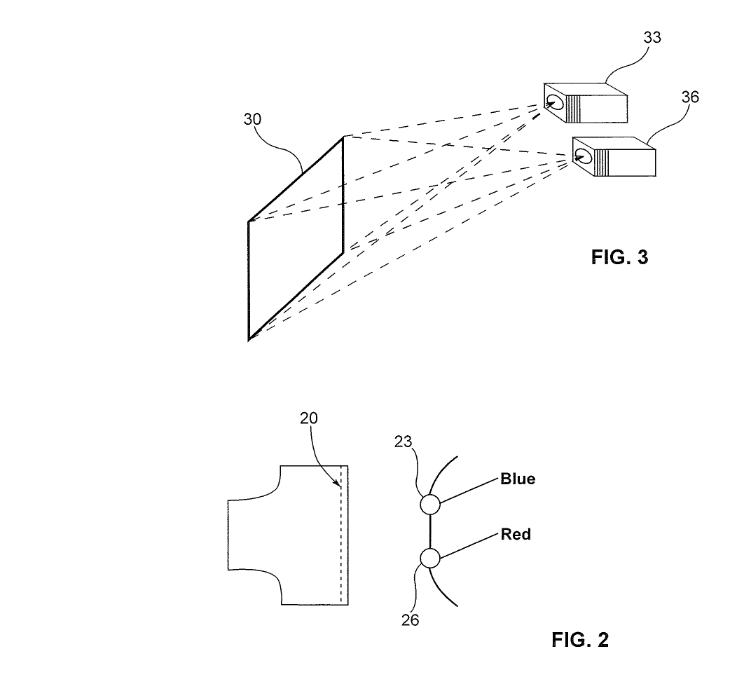

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, debris, etc.) together with the specification, and are to be considered a portion of the entire written description of this invention. As used in the following description, the terms “horizontal”, “vertical”, “left”, “right”, “up” and “down”, as well as adjectival and adverbial derivatives thereof, (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or of rotation, as appropriate.

Referring now to FIG. 3, in a first embodiment, a first set of images having a first set of frames comprising primary content such as, but not limited to, a movie or video is projected onto a viewable screen 30 by a first projector 33. A second set of images having a second set of frames, that contain alternate content, is also projected onto the screen 30 by a second projector 36. The alternate content may comprise the primary content plus additional content. As will be evident to those of ordinary skill in the art based on this disclosure, this configuration with two projectors is a simple example of a projection system, and there are many projection systems on the market that are capable of projecting multiple image streams to a viewable screen either simultaneously or alternately including digital light processing (DLP) systems, film patterned retarder (FPR) systems and the like including both front and rear projection systems. A user having a device according to the present invention, may configure a set of filtering lenses (such as, but not limited to, polarizing lenses) to alternate between viewing the first set of images and the second set of images. For example, a “main” movie and a “reveal” movie containing additional information may be played through a stereoscopic projection system as the left eye and right eye respectively. The reveal movie may contain all of the content in the main movie, plus additional content to be revealed to a subset of the viewing audience. The viewer may use eyewear with polarized lenses with both lenses being “left eye” lenses. With these left eye lenses, the viewer only sees the main movie. When the viewer wants to see the reveal information, he can switch to both “right eye” lenses or use an overlay on the “left eye” lenses which converts the left eye lenses to a right eye polarization that allows him to see the revealed information. As will be described in detail below, the system of the present invention provides multiple options for viewing the different image streams including, but not limited to, a primary lens, an overlay capable et moving into an out of alignment with the primary lens, a secondary lens, and a partial overlay for converting the eyewear into a conventional “left eye” and “right eye” configuration for viewing standard 3D movies. Also, the eyewear of the present invention may be used in connection with many types of entertainment and entertainment venues including, but not limited to, sports arenas, museums, home theaters, computers, electronic displays, printed displays, video games, live theater or the like. The eyewear may also be used in practical applications such as during operation of a motor vehicle such as to add information to the windshield. The eyewear may also be used in connection with educational applications. Also, the eyewear may be adapted for use in simulation environments and could provide proper perspective views to separate individuals depending on where they are located in the environment as determined by GPS or other tracking systems utilized by the simulation system.

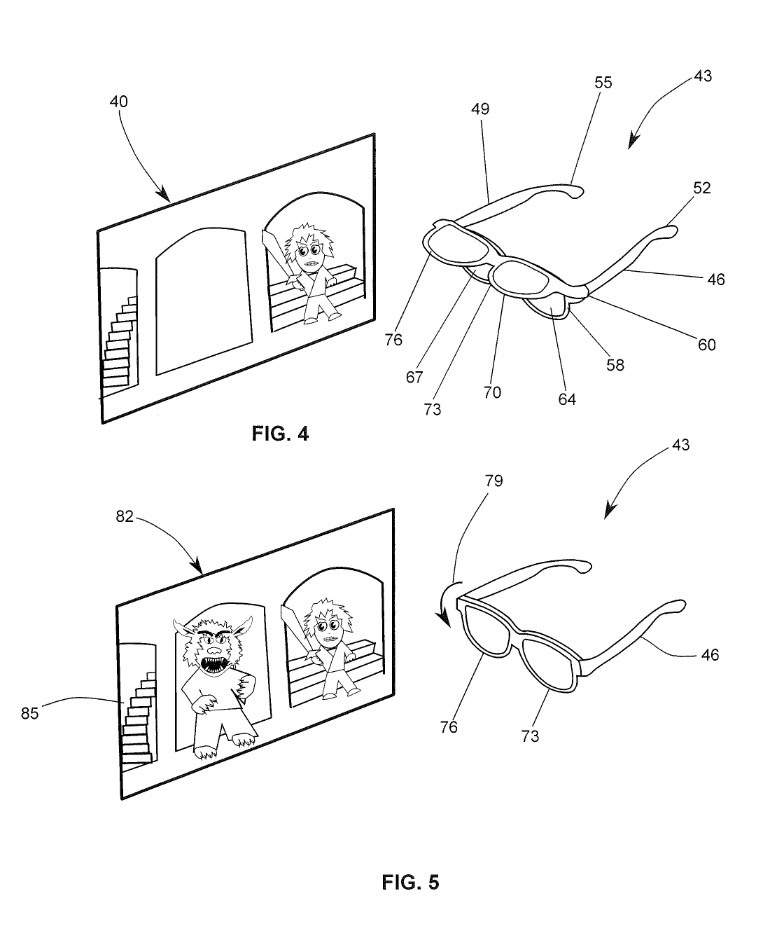

Turning to FIG. 4, the filter may comprise passive eyewear containing a manually or automated physical assembly of filter elements that enables the viewer to actively change the combination of filters through which the image streams are being received. In one embodiment a first set of images 40 comprises a main movie. Eyewear 43 may have a pair of temples 46, 49 extending to ear pieces 52, 55. The temples 46, 49 are attached to the frame 58 which includes a bridge 61 and a pair of lenses 64, 67. The eyewear 43 may include a second frame 70 that is pivotally connected to the frame 58. The second frame 70 includes lenses 73 and 76. In FIG. 5, when the second frame 70 is rotated in the direction of arrow 79, the second lenses 73 and 76 overlay the first lenses 64, 67. A second set of images 82 include the first images 40 plus additional images 85 that are revealed when the eyewear 43 is arranged with the second frame 70 overlaying the first frame 58.

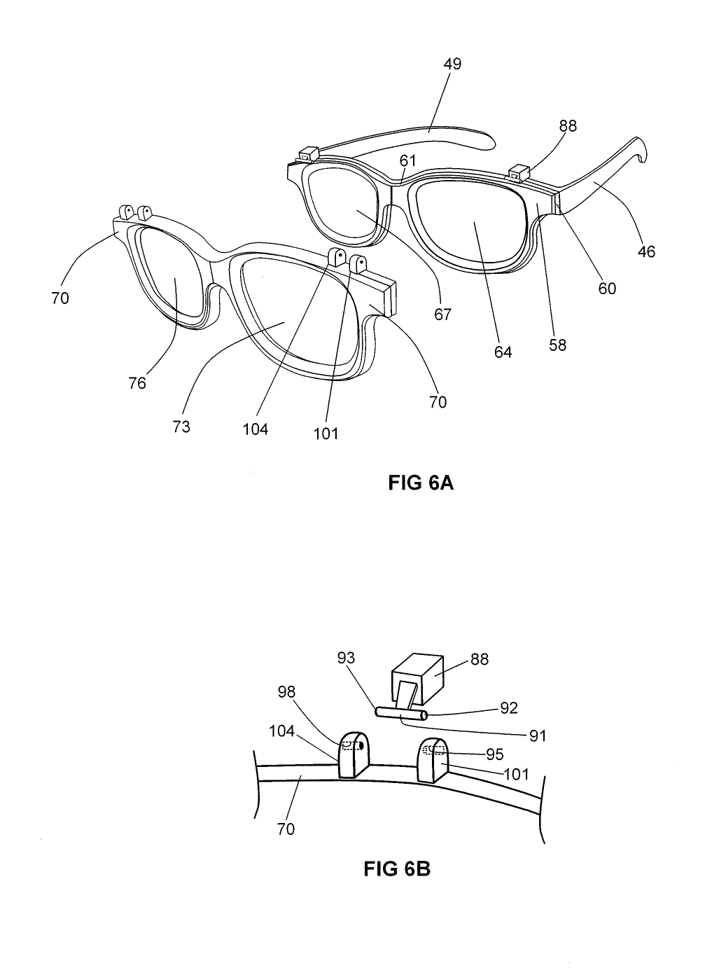

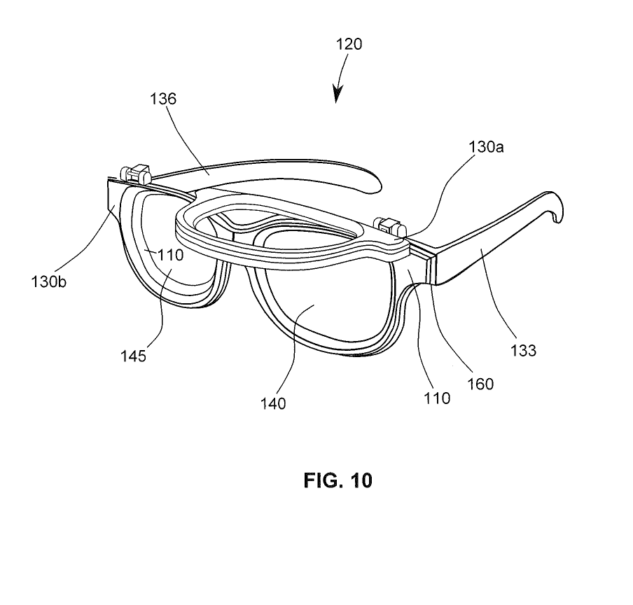

In FIG. 6A, the first embodiment eyewear 43 is shown in greater detail. Temple 46 is attached to frame 58 by means of a hinge 60. The frame 58 may include a post 88 supported from the top of the frame 58. Turning to FIG. 6B, the post 88 may include a transverse pin 91 having ends 92 and 93 extending in opposite directions. The ends 92, 93 may be received in bores 95, 98 formed in bodies 101, 104 extending from the top of the second frame 70. The bodies 101, 104 may be formed of a resilient material capable of deforming to move apart far enough to receive the ends 92, and 93 and then returning to its original shape to hold the ends 92, 93 in position inside the bores 95, 98. The bores 95, 98 may therefore provide bearing surfaces for the ends 92, 93 of the pin 91 to rotate relative to the bodies 101, 104. As a result, the second frame 70 is capable of rotating relative to the first frame 58 between a first position where the second frame 70 overlays the first frame 58 to a second position where the second frame 70 is rotated upward and out of the field of view of the user. Once the second frame 70 is rotated upward out of the field of view, a stop provides for holding the second frame 70 out of the field of the viewer (best shown in FIG. 8). As will be evident to those of ordinary skill in the art based on this disclosure, there are numerous ways to form a stop including friction latches or the like.

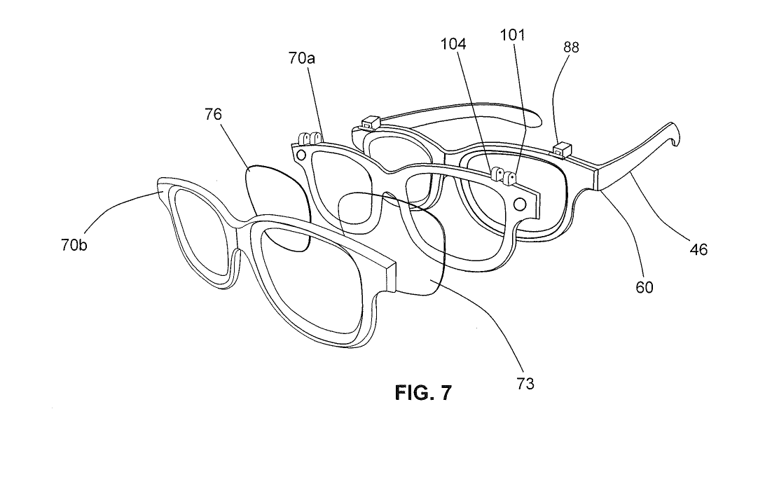

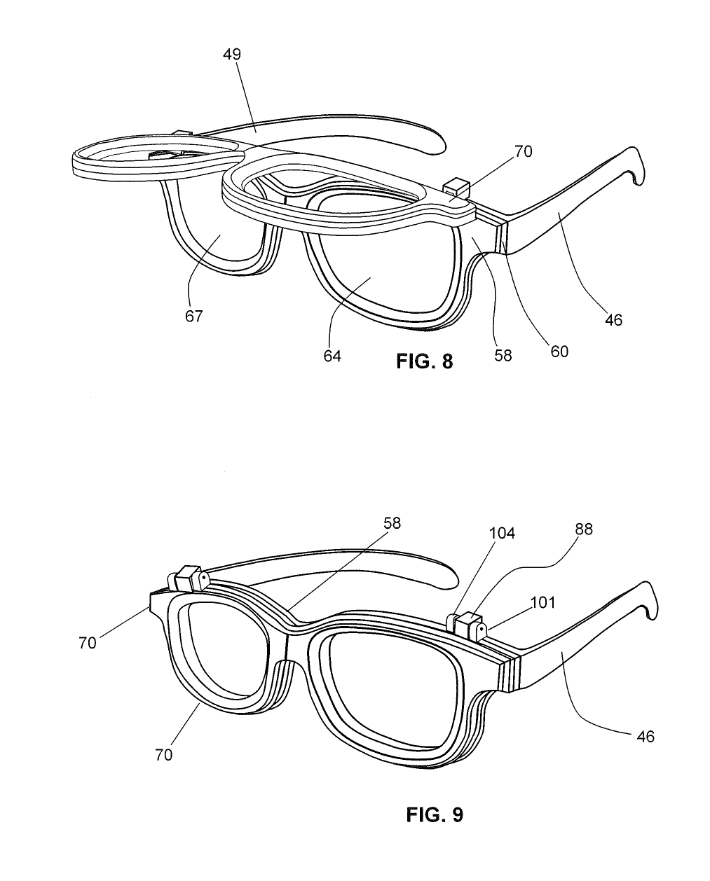

In FIG. 7, an exploded view of the first embodiment eyewear 43 shows a frame 70 having a two-piece construction. Lens 73 and 76 are disposed between a back section 70a and a front section 70b of the frame 70.

Turning to FIG. 8, the second frame 70 is shown in a second position where it is suspended out of the field of view of the user. In this position, the first frame 58 and lenses 64, 67 are the only filters in use by the viewer.

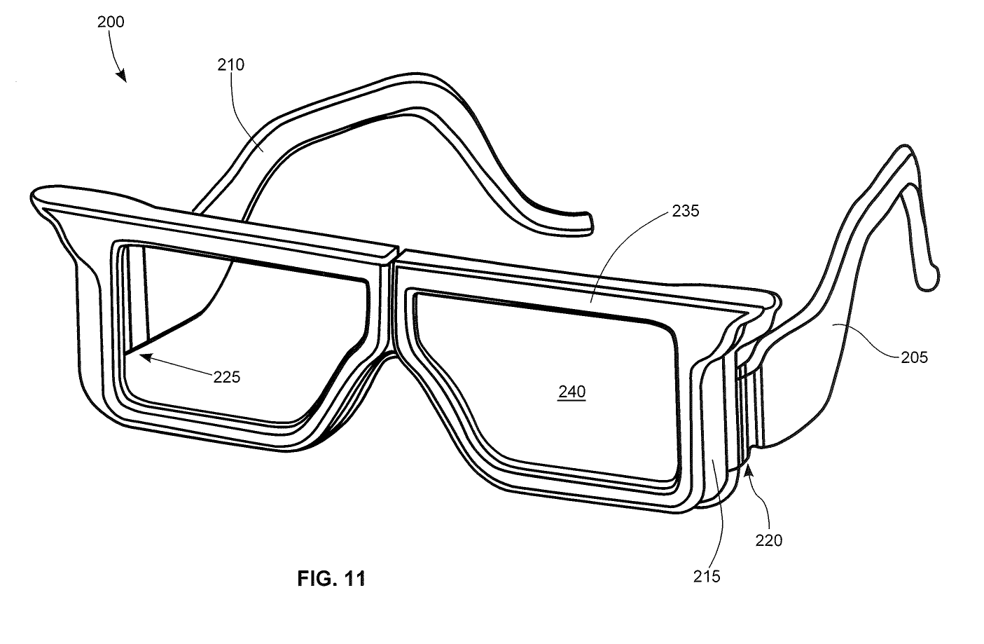

In FIG. 9, the second frame 70 is superimposed on the first frame 58. in this configuration, the user may view either: only one of the image streams being broadcast or both image streams being broadcast depending on the type of filter used in the second frame 70.

In FIG. 10, alternate embodiment eyewear 120 includes a second frame 130 that may be split in the middle to provide additional configurations. As shown one half 130a of the frame 130 is pivoted into a position where it is suspended above the field of view of the user. In this configuration, on the left hand side of the figure a second half 130b of the second frame 130 is overlaid on the first frame 110 and the other half 130a is pivoted out of view. Other possible combinations include the half 130a pivoted downward to overlay the lens 140 in the first frame 110 and the half 130b pivoted upward out of the field of view. In addition the halves 130a and 130b may be releasably connected such that they are capable of being pivoted together to move between the overlaid configuration and the upward pivoted position out of the field of view. The halves 130a and 130b may be coupled and uncoupled depending on the application. The eyewear 120 may have temples 133, 136 connected to frame 110 by hinges 160. Frame 110 holds lens 140 and frame 130b holds lens 145.

Other configurations may also be suitable including detachable individual lenses (L and R) capable of being moved into different positions to form multiple combinations in the glasses such as (L-L, R-R, L-R) to provide for different image streams to be viewed or to provide for use in the conventional 3-D filter configuration. In one embodiment, the eyewear may be configured for 3-D viewing as follows: Right eye=first filter and second filter overlay, Left eye=first filter only, or vice versa. Also in the case of more than two image streams other combinations of filter arrangements may be suitable.

Accordingly, in addition to the use of overlaying lenses to create different polarities, the filter change may be accomplished by direct substitution of one lens in place of another lens.

Also, in addition to the pivoting arrangement shown in FIGS. 6A-9, the frames 58 and 70 could be brought into and out of overlaying alignment by other means, including but not limited to sliding or rotating arrangements, or other interchangeable or superimposable arrangements as will be evident to those of ordinary skill in the art based on this disclosure. The physical assembly for filtering may include a flip-type mechanism, folding mechanism, rotating mechanism, attachable or detachable mechanism, completely detached mechanism, and any other type of interchangeable or superimposable assembly to add or remove the filters through which the multitude of image streams may be received by the user.

In addition the system may enable the viewer to select which image stream to isolate and/or enable the viewer to select which image streams to combine or overlay. Thus the system may use a DLP, FPR, or any other simultaneous multi-image projection technology.

Eyewear 43 may also be imbedded with an RFID tag to identify and track the use of the eyewear 43. This technology may be used for tracking or for promotional purposes such as rewards for frequent moviegoers.

In connection with the embodiments of the invention discussed above, the audio is synchronized for both images streams. However, independent audio streams for each image stream can be independently transmitted to each user. For example, the individual audio stream may be delivered by smart phone to a specific user. Accordingly, the eyewear 43 may be provided with ear buds and Bluetooth or wireless communication for providing audio to the user.

Another variation is the rotation of one polarized filter when overlaid with another polarized filter with the intent of gradually revealing the light/image streaming through the filters. This effect may be provided with lateral, rotational secondary frames as described herein.

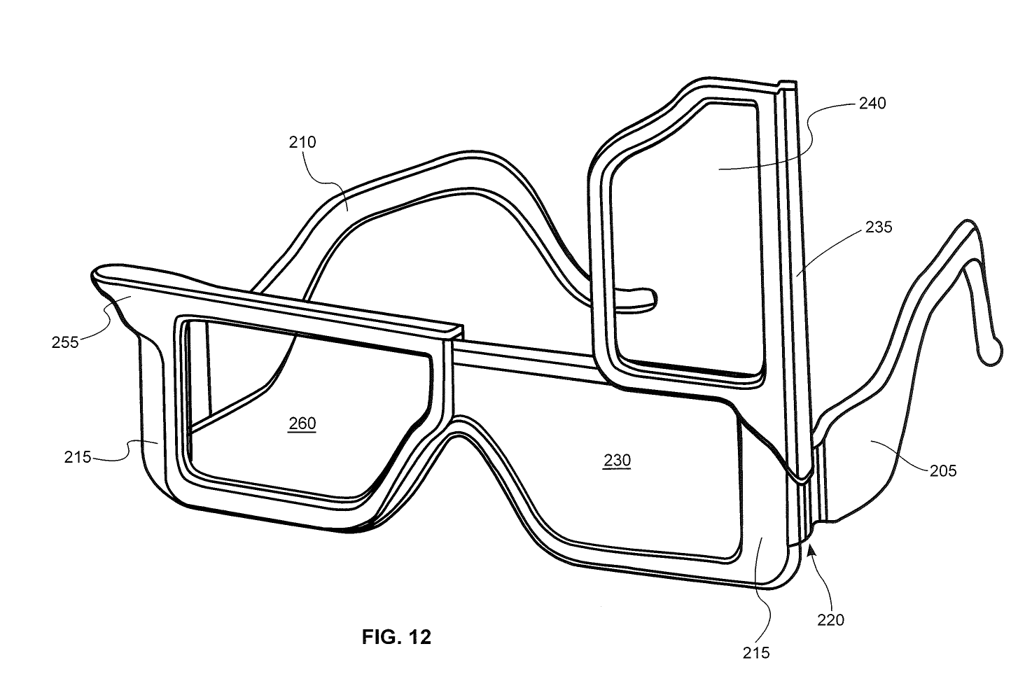

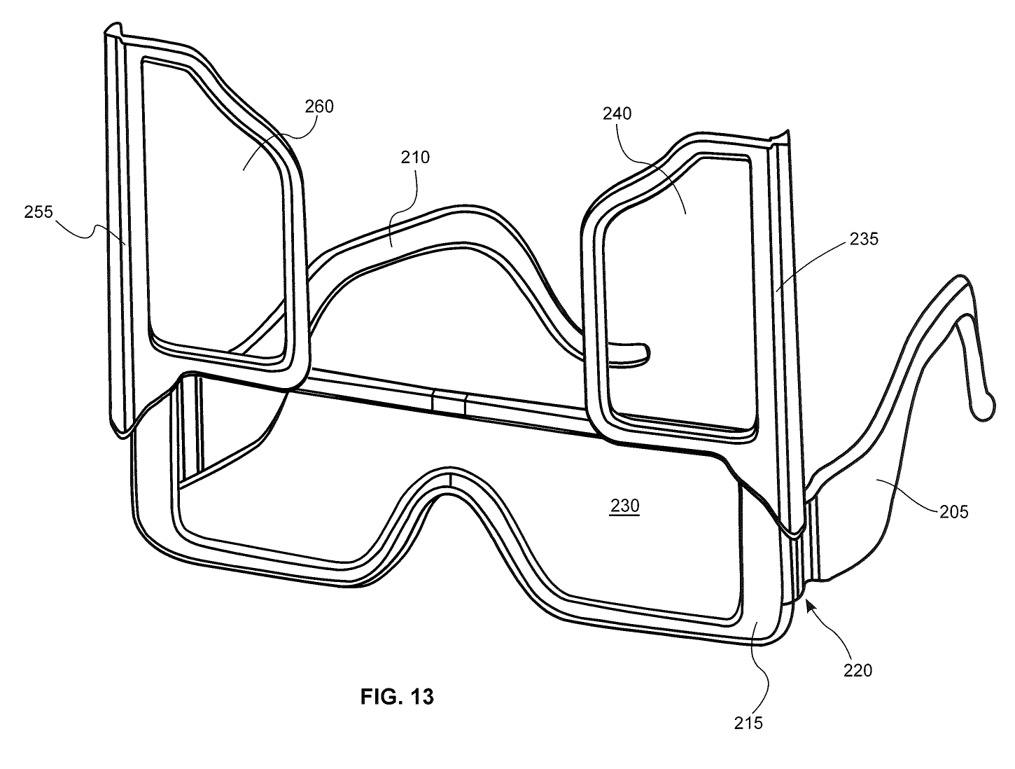

Turning to FIGS. 11-13, eyewear 200 may have temples 205, 210 connected to frame 215 by hinges 220, 225. Frame 215 may contain a lens 230 (FIG. 13) that covers both eyes. A secondary frame 235 may be pivotally attached such that it can rotate from a first position shown in FIG. 11 to a second position shown in FIG. 12. The auxiliary frame 235 may contain a lens 240. The secondary frame 235 may be attached to the frame by a mechanical, rotating arrangement such as an axle, pin or the like. The secondary frame 235 may be fixed in the retracted position shown in FIG. 12 by a releasable lock or the like. On the left side of the figure, secondary frame 255 may also be pivotally attached to the frame 215. Secondary frame 255 may also be provided with a lens 260. As shown, the eyewear 200 may be disposed in multiple configurations to provide numerous lens combinations. In FIG. 11 both secondary frames 235, 255 are positioned over the frame 215. In this configuration, the user's eyes are provided with a combined passive filter over each eye. The combined filter created by overlaying the second lens over the first lens may be designed to add or subtract images passing through the filters as will be evident to those of ordinary skill in the art based on this disclosure. As shown in FIG. 12, either auxiliary frame 235, 255 may be disposed in a retracted position. In this manner, different passive filters may be used for each eye (i.e., a combined lens on one eye and a single lens on the other eye) to form conventional stereoscopic or 3-D eyewear.

In FIG. 13, a configuration with both auxiliary frames 235, 255 in the retracted position is shown.

The present invention contemplates that many changes and modifications may be made. Therefore, while the presently-preferred form of the system has been shown and described, and several modifications and alternatives discussed, persons skilled in this art will readily appreciate that various additional changes and modifications may be made without departing from the spirit of the invention, as defined and differentiated by the following claims.

1. A method for viewing multiple image streams, the method comprising:
providing a first image stream comprising a plurality of frames;
providing a second image stream comprising a plurality of frames;
projecting the first and second image streams to a viewable screen;
providing a first passive filter for both eyes of a viewer, the first filter configured to allow the first image stream to be viewed by the user;
providing a second passive filter for both eyes of a viewer, the second filter configured to allow the second image stream to be viewed by the user;
wherein the first image stream comprises first image content and the second image stream comprises second image content not visible through the first filter.

2. The method of claim 1, wherein the first filter comprises a lens.

3. The method of claim 1, wherein the first filter comprises a lens mounted on a first eyewear frame.

4. The method of claim 1, wherein the second filter is formed by combining an overlay filter with the first filter.

5. The method of claim 4, wherein the overlay filter comprises a lens mounted on a second eyewear frame.

6. The method of claim 5, wherein the second eyewear frame is pivotally mounted to the first eyewear frame such that the second eyewear frame is capable of moving between a first position where it overlays the first eyewear frame and a second position where the second eyewear frame is disposed out of the field of view of the user.

7. The method of claim 1, wherein the first filter and second filter are formed by polarization.

8. The method of claim 1, wherein the first filter and the second filter comprise separate lenses.

9. The method of claim 1, wherein the first and second image streams are projected simultaneously.

10. The method of claim 1, wherein the first and second image streams are alternately projected onto the viewable screen.

11. A system for selectively viewing multiple image streams comprising:
a device for storing image data comprising a first image stream comprising a plurality of frames and a second image stream comprising a plurality of frames;
a device for projecting the image data onto a viewable screen;
a first passive filter for both eyes of a user, the first filter configured to allow the first image stream to be viewed by a user;
a second passive filter for both eyes of a user, the second filter configured to allow the second image stream to be viewed by a user;
wherein the first image stream comprises a first image content and the second image stream comprises a second image content not visible through the first filter.

12. The system of claim 11, wherein the first filter comprises a lens.

13. The system of claim 11, wherein the first filter comprises a lens mounted on a first eyewear frame.

14. The system of claim 11, wherein the second filter is formed by combining an overlay filter with the first filter.

15. The system of claim 14, wherein the overlay filter comprises a lens mounted on a second eyewear frame.

16. The system of claim 15, wherein the second eyewear frame is pivotally mounted to the first eyewear frame such that the second eyewear frame is capable of moving between a first position where it overlays the first eyewear frame and a second position where the second eyewear frame is disposed out of the field of view of the user.

17. The system of claim 11, wherein the first filter and second filter are formed by polarization.

18. The system of claim 11, wherein the first filter and the second filter comprise separate lenses.

19. The system of claim 11, wherein the first and second image streams are projected simultaneously.

20. The system of claim 11, wherein the first and second image streams are alternately projected onto the viewable screen.

21. A method for enabling a user to view multiple image streams, comprising:
providing a first image stream comprising a plurality of frames;
providing a second image stream comprising a plurality of frames;
projecting the first and second image streams to a viewable screen;
providing a first passive filter for one eye of a user, the first filter configured to allow the first image stream to be viewed by the user;
providing a second passive filter for the other eye of the user, the second filter configured to allow the second image stream to be viewed by the user;
wherein the first image stream comprises first image content and the second image stream comprises second image content not visible through the first filter; and,
wherein the user alternately closes each eye to switch between viewing the first and second image streams.
